(19) United States
(12) Patent Application Publication
(10) Pub. No.: US 2024/0270288 A1
(43) Pub. Date: Aug. 15, 2024

(54) Obtaining User Input

(71) Applicant: APPLE INC., Cupertino, CA (US)

(72) Inventor: Christoph Siedentop, Los Altos, CA (US)

(21) Appl. No.: 18/421,281

(22) Filed: Jan. 24, 2024

Related U.S. Application Data
(60) Provisional application No. 63/484,224, filed on Feb. 10, 2023.

(51) Int. Cl. B60W 60/00; B60W 50/14

(52) U.S. Cl. CPC B60W 60/0053; B60W 50/14; B60W 2520/14; B60W 2555/20; B60W 2720/14

(57) ABSTRACT

A method includes determining a path of travel of a motorized electronic device to move from a first location to a second location. Following the path of travel causes a baseline yaw rotation of a body of the motorized electronic device relative to the path of travel. The method further includes determining, by a control system, to notify a potential operator of the motorized electronic device. In response to determining to notify the potential operator, the method includes controlling operation of a system of the motorized electronic device using the control system to cause a change of a yaw rotation of the body of the motorized electronic device relative to the baseline yaw rotation.

### CROSS-REFERENCE TO RELATED APPLICATIONS

This application claims the benefit of U.S. Provisional Application No. 63/484,224, filed on Feb. 10, 2023, the contents of which are hereby incorporated by reference in their entirety for all purposes.

### FIELD

The present disclosure relates generally to the field of notifying a user and/or obtaining input of a user of a motorized electronic device.

### BACKGROUND

A motorized electronic device may be able to operate in an autonomous manner (e.g., with limited input from a user) in a variety of situations. In some instances, the motorized electronic device may determine that it may not be able to operate in a fully autonomous manner and may determine that input from the user may be desirable. In such instances, the motorized electronic device may notify the user to provide the input.

### SUMMARY

One aspect of the disclosure is a method that includes determining a path of travel of a motorized electronic device to move from a first location to a second location. Following the path of travel causes a baseline yaw rotation of a body of the motorized electronic device relative to the path of travel. The method further includes determining, by a control system, to notify a potential operator of the motorized electronic device. In response to determining to notify the potential operator, the method includes controlling operation of an actuator system of the motorized electronic device using the control system to cause a change of a yaw rotation of the body of the motorized electronic device relative to the baseline yaw rotation.

Another aspect of the disclosure is a non-transitory computer-readable storage device including program instructions executable by one or more processors that, when executed, cause the one or more processors to perform operations. The operations include determining a path of travel of the motorized electronic device to move from a first location to a second location, where following the path of travel causes a baseline yaw rotation of a body of the motorized electronic device relative to the path of travel. The operations also include determining to notify a potential operator of the motorized electronic device. In response to determining to notify the potential operator, the operations include controlling operation of an actuator system of the motorized electronic device to cause a change of a yaw rotation of the body of the motorized electronic device relative to the baseline yaw rotation.

Yet another aspect of the disclosure is a motorized electronic device that includes a body of the motorized electronic device and an actuator system of the motorized electronic device configured to cause motion of the body of the motorized electronic device. A control system is configured to determine a path of travel of the motorized electronic device to move from a first location to a second location. Following the path of travel causes a baseline yaw rotation of the body of the motorized electronic device relative to the path of travel. The control system is configured to determine to notify a potential operator of the motorized electronic device. In response to determining to notify the potential operator, the control system is configured to control operation of the actuator system of the motorized electronic device using the control system to cause a change of a yaw rotation of the body of the motorized electronic device relative to the baseline yaw rotation.

### BRIEF DESCRIPTION OF THE DRAWINGS

FIG. 1A is a block diagram of a motorized electronic device.

FIG. 1B is a block diagram of the motorized electronic device in a crabwalk configuration, in accordance with some embodiments.

FIG. 2 is an illustration of the motorized electronic device of FIG. 1 oriented at a first yaw rotation relative to a path of travel, in accordance with some embodiments.

FIG. 3 is an illustration of the motorized electronic device of FIG. 1 oriented at a second yaw rotation relative to the path of travel, in accordance with some embodiments.

FIG. 4 is a block diagram of a control system of the motorized electronic device of FIG. 1, in accordance with some embodiments.

FIG. 5 is a block diagram of a method of controlling operation of the motorized electronic device of FIG. 1, in accordance with some embodiments.

FIG. 6 is a block diagram of a method of controlling operation of the motorized electronic device of FIG. 1, in accordance with some embodiments.

### DETAILED DESCRIPTION

The disclosure herein relates to motorized electronic devices that are configured to operate at least partially autonomously. A motorized electronic device may determine a path of travel from a first location to a second location and may operate autonomously to move from the first location to the second location. The path of travel from the first location to the second location may include curves that, when followed by the motorized electronic device, cause a baseline yaw rotation of the motorized electronic device relative to the path of travel.

In some implementations, a control system of the motorized electronic device is configured to determine that autonomous operation of the motorized electronic device may be unavailable for an upcoming portion of the path of travel. In such implementations, the control system may determine to notify a user of the motorized electronic device that autonomous operation may be unavailable for the upcoming portion of the path of travel. The control system may control operation of the motorized electronic device to cause a change in the yaw rotation of the motorized electronic device to notify the user that autonomous operation may be unavailable for the upcoming portion of the path of travel. In some implementations, the control system may determine to obtain input from the user when autonomous operation may be unavailable, and may cause the change in the yaw rotation of the motorized electronic device to notify the user and to obtain input from the user.

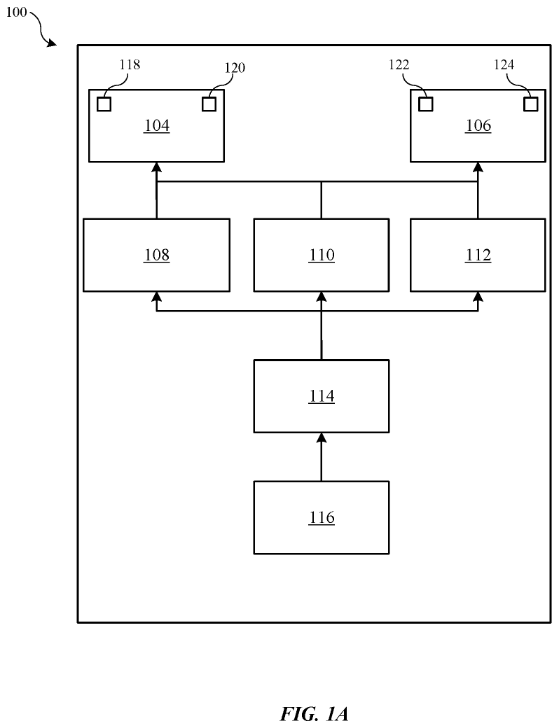

FIG. 1 is a block diagram of a motorized electronic device 100. The motorized electronic device 100 may include any type of electronic device configured to move autonomously (e.g., without intervention from a user) or partially autonomously (e.g., with some intervention from the user). For example, the motorized electronic device 100 may include a cleaning device (e.g., a vacuum, a mop, etc.), a rover device (e.g., a device configured to explore an area), or a vehicle. In some implementations the motorized electronic device 100 is configured to carry items such as cargo. In some implementations, the motorized electronic device 100 is configured to carry passengers.

The motorized electronic device 100 is shown to include a body 102. The body 102 serves as an external surface of the motorized electronic device 100 and is configured to at least partially surround various systems of the motorized electronic device 100. The body 102 may also define one or more openings through which cargo and/or passengers may enter and/or exit the motorized electronic device 100.

The motorized electronic device 100 is shown to include front wheels 104 and rear wheels 106. The front wheels 104 and the rear wheels 106 are configured to serve as an interface between the motorized electronic device 100 and a surface on which motorized electronic device 100 is traveling. In some implementations, the front wheels 104 include a front-left wheel 118 and a front-right wheel 120 and the rear wheels 106 include a rear-left wheel 122 and a rear-right wheel 124.

The motorized electronic device 100 is also shown to include a propulsion system 108. In some implementations, the propulsion system 108 is configured to rotate the front wheels 104 about a front wheel axis to move the motorized electronic device 100 along the surface on which the motorized electronic device 100 is traveling. In some implementations, the propulsion system 108 is configured to rotate the front wheels 104 about the front wheel axis and the rear wheels 106 about a rear wheel axis to move the motorized electronic device 100 along the surface on which the motorized electronic device 100 is traveling. As an example, the propulsion system 108 may include a motor (e.g., an electric motor, gas motor, diesel motor, etc.) configured to drive components such as a transmission and a drive shaft to rotate the front wheels 104 and the rear wheels 106. In some implementations, the propulsion system 108 is configured to rotate each of the front-left wheel 118, the front-right wheel 120, the rear-left wheel 122, and the rear-right wheel 124 independently of each other so that each may rotate at a different rate.

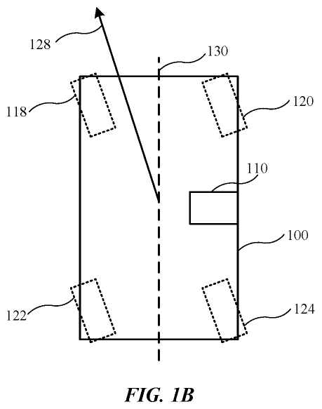

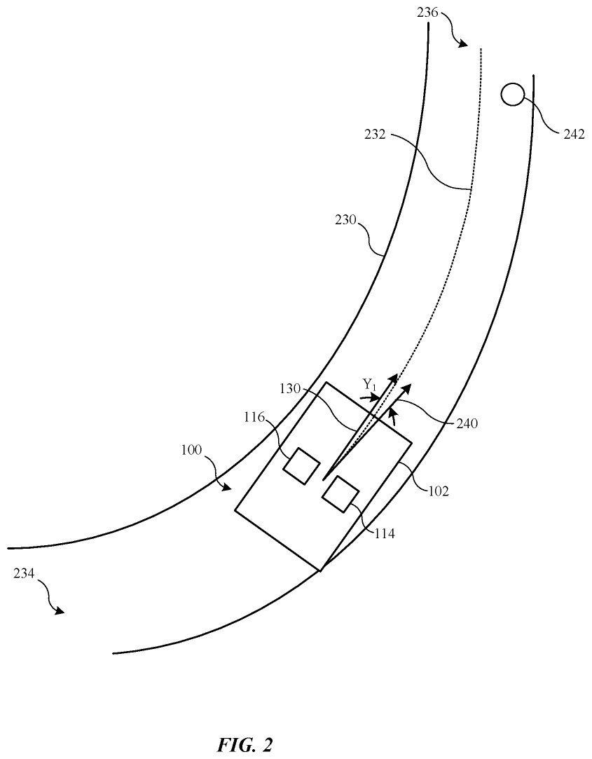

In some implementations, the propulsion system 108 is configured to rotate each of the front-left wheel 118, the front-right wheel 120, the rear-left wheel 122, and the rear-right wheel 124 independently of each other to orient the body 102 of the motorized electronic device 100 in a desired position relative to the surface on which the motorized electronic device 100 is traveling, relative to a longitudinal axis of the motorized electronic device 100, or a combination thereof. For example, the propulsion system 108 may operate the front-left wheel 118, the front-right wheel 120, the rear-left wheel 122, and the rear-right wheel 124 to change a yaw rotation relative to a baseline yaw rotation of the body 102 of the motorized electronic device 100. Such implementations are described with reference to FIGS. 2-3.

The motorized electronic device 100 also includes a brake system 112. The brake system 112 is configured to limit the rotation of the front wheels 104 and the rear wheels 106 such that the motorized electronic device 100 slows down. As an example, the brake system 112 may include friction braking components that are configured to slow rotation of the front wheels 104 and the rear wheels 106 by frictional engagement of non-rotating components (e.g., brake pads) with rotating components (e.g., brake rotors). Additionally or alternatively, a regenerative braking system may be used. In some implementations, the brake system 112 is configured to limit the rotation of each of the front-left wheel 118, the front-right wheel 120, the rear-left wheel 122, and the rear-right wheel 124 independently of each other so that each may rotate at a different rate.

In some implementations, the brake system 112 is configured to limit the rotation of each of the front-left wheel 118, the front-right wheel 120, the rear-left wheel 122, and the rear-right wheel 124 independently of each other to orient the body 102 of the motorized electronic device 100 in a desired position relative to the surface on which the motorized electronic device 100 is traveling, relative to the longitudinal axis of the motorized electronic device 100, or a combination thereof. For example, the brake system 112 may operate the front-left wheel 118, the front-right wheel 120, the rear-left wheel 122, and the rear-right wheel 124 to change a yaw rotation relative to a baseline yaw rotation of the body 102 of the motorized electronic device 100. Such implementations are described with reference to FIGS. 2-3.

The motorized electronic device 100 also includes a steering system 110. In some implementations, the steering system 110 may be configured to turn the front wheels 104 about a front steering axis and the rear wheels 106 about a rear steering axis to direct motion of the motorized electronic device 100. For example, the steering system 110 may be configured to turn the front wheels 104 and the rear wheels 106 independently of each other. More specifically, the steering system 110 may operate to turn the front wheels 104 when the motorized electronic device 100 is navigating around a curve of the surface on which the motorized electronic device 100 is traveling. The steering system 110 may also turn both the front wheels 104 and the rear wheels 106 such that the motorized electronic device 100 can turn with a smaller turn radius than if the steering system 110 turned only the front wheels 104. In such implementations, the steering system 110 is configured to turn the front wheels 104 and the rear wheels 106 in opposite directions to reduce the turn radius. For example, when turning the motorized electronic device 100 to the left, the steering system 110 is configured to turn the front wheels 104 to the left and the rear wheels 106 to the right.

As another example, and as shown in FIG. 1B, the steering system 110 of the motorized electronic device 100 is configured to turn the front wheels 104 and the rear wheels 106 in the same direction about respective steering axes such that the motorized electronic device 100 is configured to move linearly along an axis 128 (e.g., a direction of travel of the motorized electronic device 100) that is oblique to a longitudinal axis 130 of the motorized electronic device 100 (e.g., a crabwalk configuration). In such a configuration, the body 102 of the motorized electronic device 100 is oriented obliquely to the direction of travel of the motorized electronic device 100.

In some implementations, the steering system 110 is configured to move each of the front-left wheel 118, the front-right wheel 120, the rear-left wheel 122, and the rear-right wheel 124 independently of each other to orient the body 102 of the motorized electronic device 100 in a desired position relative to the surface on which the motorized electronic device 100 is traveling, relative to the longitudinal axis 130 of the motorized electronic device 100, or a combination thereof. For example, the steering system 110 may operate the front-left wheel 118, the front-right wheel 120, the rear-left wheel 122, and the rear-right wheel 124 to change a yaw rotation relative to a baseline yaw rotation of the body 102 of the motorized electronic device 100. Such implementations are described with reference to FIGS. 2-3.

The motorized electronic device 100 further includes a control system 114 and a sensor system 116. The sensor system 116 is configured to generate one or more signals indicative of an environment external to the motorized electronic device 100. For example, the sensor system 116 may include one or more sensors such as a visible light camera, an infrared camera, a light detection and ranging sensor (LIDAR), a proximity sensor, and any other type of sensor that may generate a signal indicative of the environment external to the motorized electronic device 100. The sensor system 116 may also include a global positioning system (GPS) to provide detailed maps and directions.

The control system 114 is configured to receive one or more signals from the sensor system 116 and control an actuator system (e.g., one or more of the propulsion system 108, the steering system 110, or the brake system 112) of the motorized electronic device 100 to cause a desired motion of the motorized electronic device 100. The control system 114 is further described with reference to FIGS. 2-5.

FIG. 2 is an illustration of the body 102 of the motorized electronic device 100 of FIG. 1 oriented at a first yaw rotation (Y₁) relative to a path of travel 232. FIG. 3 is an illustration of the body 102 of the motorized electronic device 100 of FIG. 1 oriented at a second yaw rotation (Y₂) relative to the path of travel 232. In some implementations, the control system 114 is configured to determine the path of travel 232 of the motorized electronic device 100 to move from a first location 234 to a second location 236 as the motorized electronic device 100 travels on a surface 230 (e.g., a road). In some implementations, the control system 114 may determine the path of travel 232 based on an output from a navigation system in communication with the control system 114. In some implementations, the control system 114 is an autonomous route and motion planning system that is configured to determine the path of travel 232 based on output from one or more sensors of the sensor system 116.

As shown, the path of travel 232 may be curved. To follow the path of travel 232, a direction 240 in which the motorized electronic device 100 is traveling is tangent to the path of travel 232 at every point along the path of travel 232. The longitudinal axis 130 of the motorized electronic device 100 is oblique to the direction 240 as the motorized electronic device 100 moves along the path of travel 232. Accordingly, following the path of travel 232 causes a baseline yaw rotation (e.g., the first yaw rotation, Y₁) of the body 102 of the motorized electronic device 100 relative to the path of travel 232. In implementations where the path of travel 232 is straight, the baseline yaw rotation may be zero relative to the path of travel 232.

As the control system 114 controls operation of the motorized electronic device 100 along the path of travel 232, the sensor system 116 generates signals indicative of the environment external to the motorized electronic device 100. The control system 114 receives the signals from the sensor system 116 and, based on the signals, may determine to notify a user of the motorized electronic device 100 and/or to obtain input from the user of the motorized electronic device 100. For example, the sensor system 116 may be configured to generate a signal indicative of an unexpected feature of the environment external to the motorized electronic device 100. More specifically, the sensor system 116 may generate a signal that indicates a mismatch between the path of travel 232 and a path of the surface 230 (e.g., a road may be under construction and the lanes may be in a location or configuration that does not match the path of travel 232). As another example, the sensor system 116 may generate a signal that indicates a poor weather condition (e.g., snow, ice, fog, etc.) that may make it difficult for the control system 114 to control operation of the motorized electronic device 100 along the path of travel 232. The sensor system 116 may also generate a signal that indicates an upcoming road condition 242 (e.g., a pothole, a crack, an icy patch, etc.). The implementations described above are not exhaustive but provide some examples of when the control system 114 is configured to notify the user and/or obtain the input from the user. The input may be a motion input to change the path of travel 232 of the motorized electronic device 100 to avoid and/or navigate through the unexpected feature or hazard. In some implementations, the control system 114 may determine to notify the user and/or obtain input from the user based on an internal requirement of the motorized electronic device 100. For example, the control system 114 may determine that one or more sensors within the motorized electronic device 100 are not operating efficiently, such as due to dirt accumulation on the sensor. In some implementations, the user is any potential operator of the motorized electronic device 100. In some implementations, the user is an occupant of the motorized electronic device 100 and may operate the motorized electronic device 100 from within the motorized electronic device 100. The user may also not be an occupant of the motorized electronic device 100, but may still provide input to the motorized electronic device 100 to operate the motorized electronic device 100.

The control system 114 may be configured to determine that different levels of autonomous control may be used on different portions of the path of travel 232. For example, based on the signals received from the sensor system 116, the control system 114 may determine that a first level of autonomous control of the motorized electronic device 100 may be used for a current portion of the path of travel 232 (e.g., at the first location 234) and a second level of autonomous control may be used for an upcoming portion of the path of travel 232 (e.g., at the second location 236). These levels may be based on those specified by the Society of Automotive Engineers (“SAE”) in the J3016 recommended practice. More specifically, the control system 114 may determine that the control system 114 can operate the motorized electronic device 100 with full automation, high driving automation, or conditional automation (e.g. the first level of autonomous control) on the current portion of the path of travel 232 because the signals from the sensor system 116 do not indicate that the user should be notified or user input should be obtained and all internal systems are operating normally. The control system 114 may also determine that the signals from the sensor system 116 indicate that the upcoming portion of the path of travel 232 includes an unexpected feature such as the upcoming road condition 242. The control system 114 may operate the motorized electronic device 100 with partial automation (e.g., the second level of autonomous control) and determine to notify the user and/or obtain input from the user to maneuver the motorized electronic device 100 around the unexpected feature when the motorized electronic device 100 is on the upcoming portion of the path of travel 232. Accordingly, the second level of autonomous control is configured to accept the input from the user to control motion of the motorized electronic device 100 when the motorized electronic device 100 is on the upcoming portion of the path of travel 232. The second level of autonomous control may include varying levels of control provided to the user. For example, the second level of autonomous control may include instances in which the user has control over the motorized electronic device 100 and some autonomous features are implemented. The second level of autonomous control may also include instances in which the user has complete control over the motorized electronic device 100 and no autonomous features are implemented.

As an example implementation, the control system 114 may determine, in advance of receiving a signal from the sensor system 116, that the first level of autonomous control is available at the first location 234 and is not available at the second location 236. The control system 114 may make the determination based on, for example, a location database or map information that includes characteristics of the first location 234 and the second location 236. The characteristics of the first location 234 and the second location 236 may include information such as surface curvature, bumpiness, height, etc. Additionally, the control system 114 may make the determination based on, for example, whether the location database or map information includes characteristics of the first location 234 and the second location 236. If the location database or map information does not include characteristics of either the first location 234 or the second location 236, the control system 114 may determine that the second level of autonomous control is required for those locations.

As described, the control system 114 may be configured to operate the motorized electronic device 100 autonomously. When the control system 114 is operating the motorized electronic device 100 autonomously, the user may not be aware that the first level of autonomous control is not available at the second location 236 based on, for example, the situations described above. In some implementations, the control system 114 is configured to control operation of a system of the motorized electronic device 100 (e.g., the propulsion system 108, the steering system 110, the brake system 112, etc.) to cause a change of a yaw rotation of the body 102 of the motorized electronic device 100 relative to the baseline yaw rotation to notify the user of a change of autonomous control. In some implementations, the control system 114 may determine to notify the user to provide input based on the change of autonomous control. For example, and as shown in FIG. 3, the control system 114 may control operation of a system of the motorized electronic device 100 to cause the body 102 of the motorized electronic device 100 to rotate to cause a yaw rotation of the body 102, Y₂, that is greater than Y₁ (the baseline yaw rotation). The control system 114 may control operation of the steering system 110 to position the front wheels 104 and the rear wheels 106 to cause the yaw rotation Y₂ while maintaining the motorized electronic device 100 on the path of travel 232. The user may experience the change in yaw rotation from Y₁to Y₂ and be notified (e.g., the user may notice a difference between an expected orientation based on Y₁ and the orientation based on Y₂). In some instances, the control system 114 may control operation of the steering system 110 such that each of the front-left wheel 118, the front-right wheel 120, the rear-left wheel 122, and the rear-right wheel 124 are operated independently of each other to cause the desired change in yaw rotation from the baseline yaw rotation.

In some implementations, the propulsion system 108 may be used to cause the change in yaw rotation from Y₁ to Y₂. For example, the control system 114 may control operation of the propulsion system 108 to change rates of rotation of one or more of the front-left wheel 118, the front-right wheel 120, the rear-left wheel 122, and the rear-right wheel 124 to cause the change in yaw rotation from Y₁ to Y₂ while maintaining the motorized electronic device 100 on the path of travel 232.

In some implementations, the brake system 112 may be used to cause the change in yaw rotation from Y₁ to Y₂. For example, the control system 114 may control operation of the brake system 112 to brake one or more of the front-left wheel 118, the front-right wheel 120, the rear-left wheel 122, and the rear-right wheel 124 to cause the change in yaw rotation from Y₁ to Y₂ while maintaining the motorized electronic device 100 on the path of travel 232.

In some implementations, the control system 114 may control operation of a system of the motorized electronic device 100 to cause a rate of change of the yaw rotation of the body 102 relative to the baseline yaw rotation of the body 102, and the rate of change has a magnitude that is greater than a threshold magnitude. For example, the control system 114 is configured to operate the propulsion system 108, the steering system 110, and/or the brake system 112 to cause a rate of change in yaw rotation of the body 102 from Y₁ to Y₂ that is fast enough to notify the user, as a gradual change may not be sufficient to notify the user. For example, the control system 114 may be configured to operate the propulsion system 108, the steering system 110, and/or the brake system 112 such that the body 102 rotates from Y₁ to Y₂ at a rate that is greater than a threshold rate of ten degrees per second. In some implementations, the threshold rate may be between five and twenty-five degrees per second, inclusive. In some implementations, the threshold rate may change as the body rotates from Y₁ to Y₂. In such implementations, the rate of change of the threshold rate may be up to ten degrees per second squared (inclusive).

In some implementations, the control system 114 may be configured to operate the steering system 110 to maintain the body 102 at Y₂ until input from the user is obtained. The control system 114 may also be configured to operate the steering system 110 to move the body 102 between Y₁ and Y₂ (e.g., oscillating the orientation of the body 102 between Y₁ and Y₂) until input from the user is obtained.

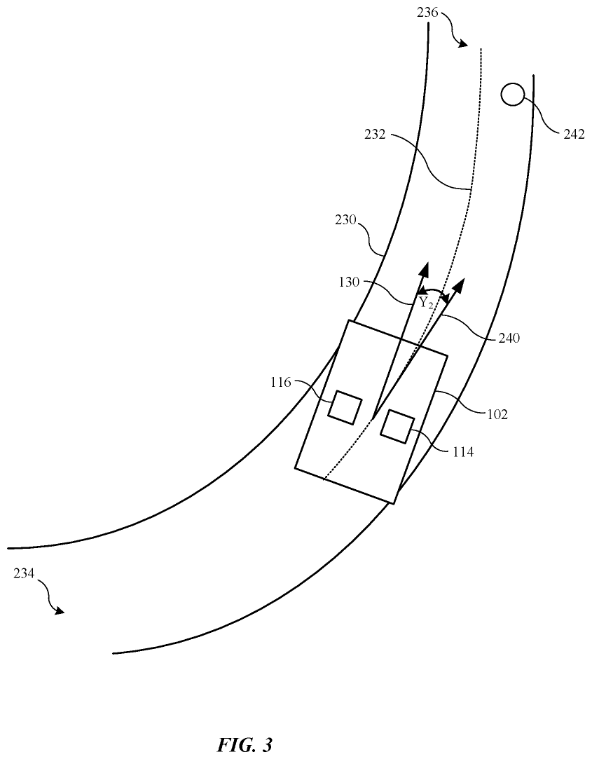

FIG. 4 is a block diagram of the control system 114 of the motorized electronic device 100 of FIG. 1. As described, the control system 114 may be configured to operate the motorized electronic device 100 as described herein. The control system 114 includes a data processing apparatus 450, a data storage device 452, a sensor interface 454, and a controller interface 456.

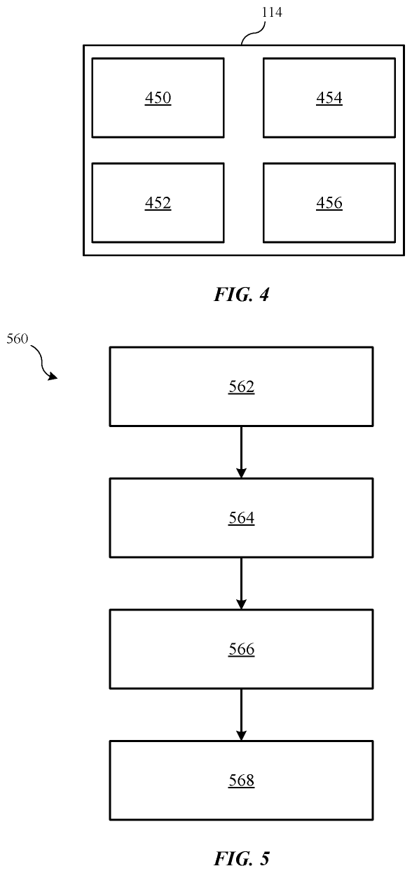

The data processing apparatus 450 is configured to execute instructions that have been stored in a data storage device 452. In some implementations, the data storage device 452 is a processor with random access memory for storing instructions read from the data storage device 452 while the instructions are being executed. The data processing apparatus 450 may include single or multiple processors each having single or multiple processing cores. Alternatively, the data processing apparatus 450 may include another type of device, or multiple devices, capable of manipulating or processing data. For example, the data storage device 452 may be a non-volatile information storage device such as a hard drive, a solid-state drive, a read-only memory device (ROM), an optical disk, a magnetic disk, or any other suitable type of storage device such as a non-transitory computer readable memory. The data storage device 452 may include another type of device, or multiple devices, capable of storing data for retrieval or processing by the data processing apparatus 450. The data storage device 452 may store instructions executable by the data processing apparatus 450 that upon execution by the data processing apparatus 450 cause the data processing apparatus 450 to perform operations, such as the operations described above and with reference to FIG. 5. below.

The sensor interface 454 may be configured to receive signals and/or data from the sensor system 116 that are directed to the data processing apparatus 450 and the data storage device 452. In some implementations, the sensor interface 454 may include a wireless interface for communicating with one or more sensors of the sensor system 116 via low-power, short-range communications (e.g., using a network protocol of the motorized electronic device 100).

The controller interface 456 allows input of information to, and output of information from, other systems within the motorized electronic device 100 to facilitate control of the motorized electronic device 100. For example, the controller interface 456 may be configured to issue control signals to systems in the motorized electronic device 100 (e.g., the propulsion system 108, the steering system 110, the brake system 112, etc.) and to receive sensor data from the sensor system 116. For example, the controller interface 456 may be a system bus, or a wired or wireless network (e.g., an area network of the motorized electronic device 100).

FIG. 5 is a block diagram of a method 560 of controlling operation of the motorized electronic device 100 of FIG. 1. The method 560 may be implemented, at least in part, by the control system 114.

At operation 562, a path of travel is determined. For example, the control system 114 may determine the path of travel 232 for the motorized electronic device 100 to travel from the first location 234 to the second location 236. As described, following the path of travel 232 may cause a baseline yaw rotation of the body 102 of the motorized electronic device 100 relative to the path of travel 232.

At operation 564, a signal is generated that is indicative of a feature. For example, the sensor system 116 may generate a signal that is indicative of the upcoming road condition 242 (e.g., an unexpected feature such as a road condition like a pothole, bump, ice patch, or other obstruction). In some implementations, the sensor system 116 may generate a signal indicative of poor visibility due to inclement weather conditions (e.g., snow, wind, rain, etc.). The signal generated by the sensor system 116 is received by the control system 114.

At operation 566, a determination is made to notify the user and/or obtain input from the user of the motorized electronic device 100. For example, the control system 114 may determine to notify the user and/or obtain input from the user based on the signal received in operation 564. More specifically, the control system 114 may determine, based on the signal generated by the sensor system 116, to obtain input from the user to maneuver the motorized electronic device 100 around the unexpected feature (e.g., the upcoming road condition 242). In another implementation, the control system 114 may determine, based on the signal generated by the sensor system 116, to notify the user and/or obtain the input from the user based on a weather condition. In some implementations, the control system 114 may determine to notify the user and/or obtain input from the user based on the level of autonomous driving that is available at different locations along the path of travel 232. For example, the control system 114 may determine that, based on available map data, the second level of autonomous control may be used for an upcoming portion of the path of travel 232 (e.g., after exiting a highway, turning on to an unmapped road, etc.). The control system 114 may determine to notify the user of the change in autonomous levels of control and/or obtain input from the user to navigate the upcoming portion of the path of travel 232.

At operation 568, operation of the motorized electronic device 100 is controlled by the control system 114. For example, the control system 114 may control operation of a system of the motorized electronic device 100 (e.g., the propulsion system 108, the steering system 110, the brake system 112, etc.) to cause a change of the yaw rotation of the body 102 of the motorized electronic device 100 relative to the baseline yaw rotation to notify the user of a change in autonomous control levels. In some implementations, the control system 114 may cause the change of the yaw rotation of the body 102 relative to the baseline yaw rotation to notify the user to provide the input. As described, causing the change in the yaw rotation of the body 102 relative to the baseline yaw rotation includes causing a rate of change of the yaw rotation of the body 102 relative to the baseline yaw rotation, wherein the rate of change has a magnitude that is greater than a threshold magnitude. In some implementations, the control system 114 may control operation of the motorized electronic device 100 at the time for the user to provide the input. The control system 114 may also control operation of the motorized electronic device 100 in advance of when the user provides the input to allow the user time to prepare to provide the input.

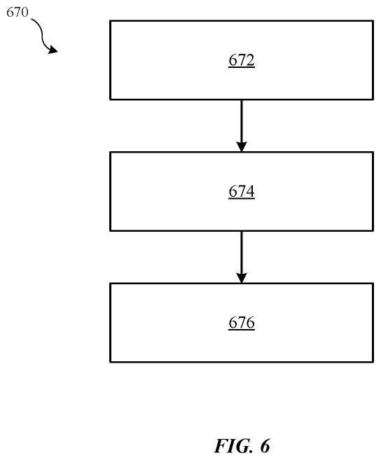

FIG. 6 is a block diagram of a method 670 of controlling operation of the motorized electronic device 100 of FIG. 1. The method 670 may be implemented, at least in part, by the control system 114.

At operation 672, a path of travel is determined. For example, the control system 114 may determine the path of travel 232 for the motorized electronic device 100 to travel from the first location 234 to the second location 236. As described, following the path of travel 232 may cause a baseline yaw rotation of the body 102 of the motorized electronic device 100 relative to the path of travel 232.

At operation 674, a level of autonomy is determined based on the path of travel 232. For example, the control system 114 may determine, based on the path of travel 232, whether the motorized electronic device 100 can operate using the first level of autonomy or the second level of autonomy, as described above. More specifically, the control system 114 may determine, based on map and/or location data (e.g., provided by a GPS system, by the sensor system 116, etc.), whether the path of travel 232 corresponds to a location where the first level of autonomy is available, or if the path of travel 232 corresponds to a location in which the first level of autonomy is not available, in which case the second level of autonomy may be used. As one example, the control system 114 may determine whether autonomy features are available based on an explicit designation, included in information that is available to the control system 114, that indicates whether the first level of autonomy or the second level of autonomy are available on a particular roadway corresponding to the path of travel 232.

In some implementations, data available for the path of travel 232 may be insufficient for the control system 114 to control operation of the motorized electronic device 100 under the first level of autonomy. Insufficient data may result from a network outage, a lack of detailed mapping of the area, etc. In such implementations, the control system 114 may determine to operate the motorized electronic device 100 under the second level of autonomy.

In an example implementation, the control system 114 may determine that the motorized electronic device 100 is traveling on a major through way, and that the motorized electronic device 100 may operate under the first level of autonomy. If the control system 114 determines that the motorized electronic device 100 is traveling on a back road or parking lot, the control system 114 may determine that the motorized electronic device 100 may operate under the second level of autonomy. In some implementations, the motorized electronic device 100 may be operating under the first level of autonomy on a through way, and the path of travel 232 may indicate that the motorized electronic device 100 will be entering a parking lot. In such implementations, the control system 114 may determine to operate the motorized electronic device 100 under the first level of autonomy until a threshold distance or duration is met. For example, the control system 114 may determine that the motorized electronic device 100 may switch from the first level of autonomy to the second level of autonomy at a predetermined distance prior to the parking lot, such as at least one mile prior to reaching the parking lot. As another example, the control system 114 may determine that the motorized electronic device 100 may switch from the first level of autonomy to the second level of autonomy at least two minutes prior to the transition. The threshold distance may include other suitable distances (e.g., two miles, five miles, etc.), and the threshold duration may include other suitable durations (e.g., thirty seconds, one minute, three minutes, etc.).

At operation 676, operation of the motorized electronic device 100 is controlled by the control system 114. For example, operation of the motorized electronic device 100 may be controlled similar to operation 568 of FIG. 5. Using the above example, the control system 114 may change the yaw rotation of the body 102 of the motorized electronic device 100 relative to the baseline yaw rotation to notify the user of a change in autonomous control levels. In some implementations, the control system 114 may cause the change of the yaw rotation of the body 102 relative to the baseline yaw rotation to notify the user to provide the input. As described, the control system 114 may cause a change in yaw rotation of the body 102 when the motorized electronic device 100 is within the threshold distance or duration of moving from the first level of autonomy to the second level of autonomy. In the examples above, the input from the user may include controlling the motorized electronic device 100 to move the motorized electronic device 100 from a road into a stopping area.

As described above, one aspect of the present technology is the gathering and use of data available from various sources for use in controlling operation of the motorized electronic device 100. To the extent the information gathered to provide the above-described techniques include personal information data, such as those that uniquely identifies or can be used to contact or locate a specific person, parties that implement this technology are reminded to implement and consistently use privacy policies and practices that are generally recognized as meeting or exceeding industry or governmental requirements for maintaining personal information data private and secure. Implementers are also reminded that various techniques may be used to implement the present technology in a manner that protects user privacy. For example, local device processing may be preferred over transmission of data to online servers for processing. Further, data may be anonymized, for example a list of the attractions that a particular user is interested in may be communicated without specifically identifying the user. Users may also be permitted to opt-in and/or opt-out of certain features in accordance with their privacy preferences. In addition, it is the intent of the present disclosure that any personal information data should be managed and handled in a way to minimize risks of unintentional or unauthorized access or use.

What is claimed is:

1. A method, comprising:
determining a path of travel of a motorized electronic device to move from a first location to a second location, wherein following the path of travel causes a baseline yaw rotation of a body of the motorized electronic device relative to the path of travel;
determining, by a control system, to notify a potential operator of the motorized electronic device; and
in response to determining to notify the potential operator, controlling operation of an actuator system of the motorized electronic device using the control system to cause a change of a yaw rotation of the body of the motorized electronic device relative to the baseline yaw rotation.

2. The method of claim 1, wherein controlling operation of the actuator system of the motorized electronic device to cause the change in the yaw rotation of the body relative to the baseline yaw rotation includes causing a rate of change of the yaw rotation of the body relative to the baseline yaw rotation, wherein the rate of change has a magnitude that is greater than a threshold magnitude.

3. The method of claim 1, wherein determining to notify the potential operator includes determining, by the control system, that a first level of autonomous control of the motorized electronic device may be used for a current portion of the path of travel and a second level of autonomous control of the motorized electronic device may be used for an upcoming portion of the path of travel, wherein the second level of autonomous control is configured to accept an input from the potential operator to control motion of the motorized electronic device when the motorized electronic device is on the upcoming portion of the path of travel.

4. The method of claim 3, wherein the input is a motion input to change the path of travel of the motorized electronic device, and the potential operator is an occupant in the motorized electronic device.

5. The method of claim 1, further comprising:
generating, by a sensor, a signal indicative of an unexpected feature of an environment external to the motorized electronic device; and
determining, by the control system, to obtain an input from the potential operator to maneuver the motorized electronic device around the unexpected feature.

6. The method of claim 5, wherein the unexpected feature is a road condition.

7. The method of claim 1, wherein the control system is an autonomous route and motion planning system.

8. The method of claim 1, wherein determining to notify the potential operator is based on a weather condition.

9. A non-transitory computer-readable storage device including program instructions executable by one or more processors that, when executed, cause the one or more processors to perform operations, the operations comprising:
determining a path of travel of a motorized electronic device to move from a first location to a second location, wherein following the path of travel causes a baseline yaw rotation of a body of the motorized electronic device relative to the path of travel;
determining to notify a potential operator of the motorized electronic device; and
in response to determining to notify the potential operator, controlling operation of an actuator system of the motorized electronic device to cause a change of a yaw rotation of the body of the motorized electronic device relative to the baseline yaw rotation.

10. The non-transitory computer-readable storage device of claim 9, wherein controlling operation of the actuator system of the motorized electronic device to cause the change in the yaw rotation of the body relative to the baseline yaw rotation includes causing a rate of change of the yaw rotation of the body relative to the baseline yaw rotation, wherein the rate of change has a magnitude that is greater than a threshold magnitude.

11. The non-transitory computer-readable storage device of claim 9, wherein determining to notify the potential operator includes determining that a first level of autonomous control of the motorized electronic device may be used for a current portion of the path of travel and a second level of autonomous control of the motorized electronic device may be used for an upcoming portion of the path of travel, wherein the second level of autonomous control is configured to accept an input from the potential operator to control motion of the motorized electronic device when the motorized electronic device is on the upcoming portion of the path of travel.

12. The non-transitory computer-readable storage device of claim 9, the operations comprising:
generating a signal indicative of an unexpected feature of an environment external to the motorized electronic device; and
determining to obtain an input from the potential operator to maneuver the motorized electronic device around the unexpected feature.

13. The non-transitory computer-readable storage device of claim 12, wherein the unexpected feature is a road condition.

14. The non-transitory computer-readable storage device of claim 9, wherein determining to notify the potential operator is based on a weather condition.

15. A motorized electronic device, comprising:
a body of the motorized electronic device;
an actuator system of the motorized electronic device configured to cause motion of the body of the motorized electronic device;
a control system configured to:
determine a path of travel of the motorized electronic device to move from a first location to a second location, wherein following the path of travel causes a baseline yaw rotation of the body of the motorized electronic device relative to the path of travel;
determine to notify a potential operator of the motorized electronic device; and
in response to determining to notify the potential operator, controlling operation of the actuator system of the motorized electronic device using the control system to cause a change of a yaw rotation of the body of the motorized electronic device relative to the baseline yaw rotation.

16. The motorized electronic device of claim 15, wherein controlling operation of the actuator system of the motorized electronic device to cause the change in the yaw rotation of the body relative to the baseline yaw rotation includes causing a rate of change of the yaw rotation of the body relative to the baseline yaw rotation, wherein the rate of change has a magnitude that is greater than a threshold magnitude.

17. The motorized electronic device of claim 15, wherein determining to notify the potential operator includes determining that a first level of autonomous control of the motorized electronic device may be used for a current portion of the path of travel and a second level of autonomous control of the motorized electronic device may be used for an upcoming portion of the path of travel, wherein the second level of autonomous control is configured to accept an input from the potential operator to control motion of the motorized electronic device when the motorized electronic device is on the upcoming portion of the path of travel.

18. The motorized electronic device of claim 15, further comprising a sensor configured to generate a signal indicative of an unexpected feature of an environment external to the motorized electronic device, wherein the control system is configured to obtain an input from the potential operator to maneuver the motorized electronic device around the unexpected feature.

19. The motorized electronic device of claim 18, wherein the unexpected feature is a road condition.

20. The motorized electronic device of claim 15, wherein the control system is an autonomous route and motion planning system.
